(19) United States
(12) Patent Application Publication
(10) Pub. No.: US 2025/0288894 A1
(43) Pub. Date: Sep. 18, 2025

(54) Billiards Table Slate Lift System

(71) Applicant: Valley-Dynamo, LP, Richland Hills, TX (US)

(72) Inventors: Kelye B Stites, Colleyville, TX (US); Martin G Bohn, North Richland Hills, TX (US)

(73) Assignee: Valley-Dynamo, LP, Richland Hills, TX (US)

(21) Appl. No.: 19/080,260

(22) Filed: Mar. 14, 2025

Related U.S. Application Data
(60) Provisional application No. 63/565,838, filed on Mar. 15, 2024.

(51) Int. Cl. A63D 15/00; B66F 3/12

(52) U.S. Cl. CPC A63D 15/00; B66F 3/12

(57) ABSTRACT

A billiards table slate lift system includes a lift system supported by tub of the billiards table below a one-piece slate bed that is supported both by the tub and a slate support system also supported by the tub and located below the bed. The slate lift system permits a single user to raise the bed using a power drill, put it into a safe configuration supported by the slate support system, and safely reach under the edge of the bed to conduct maintenance on the cloth covering the bed, and then lower the bed into place. The tub includes end sections and side sections joined by corner members. The end and side sections include underrails and walls.

### REFERENCE TO RELATED APPLICATIONS

This application claims priority to provisional application Ser. No. 63/565,838 and incorporates that application in its entirety.

### FIELD OF THE INVENTION

The invention relates to gaming tables having large and heavy gaming surfaces that have to be supported in use and lifted up for maintenance. In particular, the invention relates to billiards (including pool, or pocket billiards) tables having a one-piece bed (or slate), including coin-operating/commercial tables of this type. Such a bed is covered with billiard cloth and supported by a tub. The tub is a framed structure that provides vertical and lateral support to the bed and also supports other parts of the table, such as legs, ball pockets, rails, blinds, return equipment, etc. Billiard cloth requires periodic maintenance, which includes lifting the bed from the tub to remove the existing cloth, and place, stretch, and glue the new cloth (including to the underside of the bed), then lowering the bed back onto the tub.

### BACKGROUND OF THE INVENTION

The present invention solves a problem with tables with one-piece beds (one-piece tables), which is that the beds are commonly made of slate. Pool tables, in particular, range from 7, 8, 8.5 to 9 feet in length, at a 2:1 ratio length-to-width. As such, the one-piece slate bed can weigh from 350-400 pounds, to even 430 pounds.

This means the cloth maintenance process would require at least two workers (or four) to lift the bed into a position to permit the maintenance to occur (and to replace it following cloth replacement). In most cases, however, only one of those workers is needed for the cloth replacement part of the maintenance (removing, placing, stretching, and gluing). Thus, two or more workers must be supplied, travel to the table's location, but one or more will be idle for much of the time. A billiards table having a mechanical slate lift system for a one-piece bed, operable by a single worker, is desired.

One-piece beds also require support within the billiards table to prevent sagging or cracking. A support structure, typically transverse across the width of the billiards table, is supported by the tub. This amount of weight can stress or deform components of the tub or require reinforcement of those components to avoid deformation of the bed. A billiards table having a slate support structure that better performs those functions without additional reinforcement is desired.

### BRIEF STATEMENT OF THE INVENTION

In an embodiment, a billiards table includes a tub, a one-piece bed that is supported by the tub, a lift system that is supported by the tub and is located below the one-piece bed, and a slate support system that is supported by the tub and is located below the one-piece bed. The billiards table also includes legs, and a top assembly, which includes top rails, the ball pockets, and die castings around the ball pockets. The table also includes a coin mechanism, and a ball return mechanism. The top assembly is fixed using bolts in the top rails and die castings to the underrails of the tub and can be removed therefrom by removing the bolts, and be replaced by reinstalling the bolts.

The one-piece bed is formed of a single piece of slate without any manufactured joints, and has a top surface, edges, a bottom surface, and a center of gravity. The bed is covered with cloth, attached thereto with glue. The cloth covers the top surface, around the edges, and extends onto the bottom surface, to facilitate the cloth being tightened and fixed to the bed.

The tub is supported by the legs, and supports the top assembly, coin mechanism, and ball return mechanism. It also supports, directly or indirectly (depending upon configuration for the bed), the bed, the lift system, and the slate support system. The tub includes corner members, two opposed end sections, and two opposed side sections, forming partial edges of a rectangle, where each end section is connected by a corner member on both of its ends to one each of the side sections, and where each side section is connected by a corner member on both of its ends to one each of the end sections. The end sections and side sections form, with the corner members, an essentially rigid and strong supporting structure. The end sections and side sections are formed of wood or wood products, but might be formed of other materials.

The end sections each include an end underrail and an end wall. The end walls each have a larger surface that is an end-facing surface and an end joint edge of that end-facing surface. The side sections each include a side underrail and a side wall. The side walls each have a larger surface that is a side-facing surface and a side joint edge of that the side-facing surface. The larger, outward-facing surfaces of the side walls and end walls are close to vertical, but are angled outward as they extend upward. Each of those larger faces has a normal vector about 7 degrees below horizontal. In another embodiment (not shown), the normal vector of the larger faces is horizontal and the larger faces are vertical. In another embodiment (not shown), the normal vector of the larger faces is within about 10 or 20 degrees of horizontal. Being oriented close to vertical, the end walls and side walls have a very great capacity to resist bending (bending moment) due to a downward force. A drill access hole is provided in one of the side walls to permit a user (not shown) access to the drill connection at the exterior end of the crank extension.

The end underrails and side underrails each have a slate support face, on an upper side, and a wall joint recess on a lower side. The slate support face supports the bed. The slate support face is formed in a slate recess on that upper side to prevent lateral translation of the bed.

The end joint edges of each end wall are inserted into the lower wall joint recess of an end underrail forming joints edgewise (e.g. by gluing, epoxy, mechanical connectors, etc.). Likewise, the side joint edges of each side wall are inserted into the lower wall joint recess of a side underrail forming joints edgewise. As the corner members connect the end sections to the side sections, and the end underrails to the side underrails, the end underrails and side underrails form partial edges of a rectangle.

Each of the side underrails and side walls have a pair of pockets formed therein on either side of a midline thereof and across from one another. This places the pockets on either side of the midline of the billiards table and of the bed, and on either side of the center of gravity of the bed. The pockets are for accepting, and supporting vertically, ends of the slate support rails and forming the integrated slate supports. The pockets cut downward through the slate support surface, and partially through the wall joint recess, but not through the side underrails; thus, the ends of the slate support rails rest on the side underrails in the pockets and are supported thereby. As the pockets extend partially through the wall joint recess, and cut into the side joint edge of the side wall, the ends of the slate support rails also rest on the side walls in the pockets and are supported thereby.

The lift system includes a scissors lift and a push plate assembly. The lift system may be supported by the slate support system.

The push plate assembly includes an upper push plate above upper ends of the scissors lift, and a lower push plate below the lower ends of the scissors lift. The upper and lower push plates each include a rolling surface (interiorly) and a pushing surface (exteriorly). The pushing surface of the upper push plate is located below and aligned to the center of gravity of the bed, and configured to contact the bed at that point as it is extended (moved to a contact, raised, and safety configuration). The pushing surface of the lower push plate is supported by the box bottom of the lift box of the slate support system. The rolling surfaces accept and retain the rolling members of the scissors lift to permit it to extend and retract. The lower push plate includes an anchor connection that fixes the anchored lower end of the scissors lift to the lower push plate. That connection may be a set of pins through a set of aligned holes on the anchored lower and the lower push plate. The upper push plate may likewise include an anchor connection that fixes one of the upper ends of the scissors lift to the upper push plate.

The scissors lift includes an anchored lower end and a moving lower end, and two upper ends. The scissors lift also includes a pair of struts that connect the anchored lower end to one of the upper ends, and another pair of struts that connect the moving lower end to the other upper end. There is a pinned strut connection between the first pair of struts and the second pair of struts at or around the midpoints thereof to permit the struts to scissor, and thus to extend and to retract. The lower ends are elongated rectangular pieces having axles at each end. The upper ends are elongated pieces that have axles at each end. Each strut connects one end of an upper end to the same end of a lower end by being rotatably connected to the respective axles of the upper ends and the lower ends. On the axles of the upper ends and lower ends, distally of the struts, are rolling members that permit the upper ends and the moving lower end to roll along the rolling surface of the lower push plate during the scissoring motion. The rolling members on the anchored lower end may only rotate relative to the rolling surface, as it is pinned to the lower push plate by the anchor connection to prevent lateral motion (translation) therebetween (and one of the upper ends may likewise be pinned permitting only rotation relative to the rolling surface of the upper push plate).

The moving lower end includes a threaded connection near the midpoint thereof, and the anchored lower end has a rotating collar near the midpoint thereof. The scissor lift includes a crank extension that is a rotating rod having an acme thread. The crank extension connects the anchored lower end to the moving lower end, transversely to each. The crank extension has a drill connection at its exterior end, which extends to or near the drill access hole in one of the side walls, and permits a user (not shown) to use a power drill (e.g. a cordless drill) to drive the crank extension to rotate. The crank extension is connected by the rotating collar (lock collar) between its exterior end and the opposite (interior) end to the anchored lower end and threaded through the threaded connection of the rotating collar to the moving lower end closer to the interior of the crank extension.

The crank extension can rotate relative to both of the lower ends (via the threaded connection and the rotating collar) but can only translate relative to one of those lower ends. The crank extension cannot translate relative to the anchored lower end because the rotating collar fixes it axially thereto. But the moving lower end can, and must, translate relative to the crank extension as the crank extension is rotated because the crank extension is connected thereto by threaded connection. Thus, driving the crank extension in one direction will force moving lower end closer to anchored lower end (by rolling on rolling members along the rolling surface of lower push plate) to extend the scissors lift upward. In doing so, one or both of the upper ends rolling on rolling members along the rolling surface of upper push plate also allows that scissoring motion. And driving the crank extension in the opposite direction will force moving lower end farther from anchored lower end (likewise by rolling) to retract the scissors lift downward, with one or both of the upper ends likewise rolling.

In another embodiment, the positions of the anchored lower end and moving lower end could be reversed, or the positioning of the threaded connection and rotating collar thereon could be reversed. In either case, the rotation of the threaded crank extension, the inability of the crank extension to translate axially relative to only one of the two ends to which it is connected, the lateral fixing (inability to translate) of one of the ends relative to the push plate assembly, and freedom of the other end to move laterally (translate) relative to the push plate assembly, permits a scissoring motion (extension/retraction) by the lift system.

The slate support system is supported by the tub and includes a lift box, and one or more (in this embodiment, two) integrated slate supports fixed to the lift box.

The integrated slate supports have opposing ends and extend transversely (from side wall to side wall), with each of the opposing ends supported by the tub. The ends of the integrated slate supports are supported by the tub by being received and supported by the pockets in the side walls and side underrails. The integrated slate supports may take the form of two slate support rails. Each of the slate support rails have two opposing ends and a channel-shaped cross-section therebetween, forming a channel in which the open side faces upwards. Likewise, each of the opposing ends are supported by the tub. The integrated slate supports and slate support rails contact the bed except when it has been lifted; they act to support the bed to prevent slumping or cracking were the bed supported only around the periphery by the underrails, and to avoid allowing the bed to deform downwards in a way that reduces the desired flatness.

The lift box supports the lift system, and includes box bottom on which the lower push plate rests and which supports the lower push plate. The lift box is deep enough that the scissors lift can retract enough that the upper push plate does not contact the bed, so that the lift system can reach a lowered configuration forming a spacing gap. This is to avoid deforming the bed upwards in a way that reduces the desired flatness. The lift box is integrated with the integrated slate supports, and fixed to each slate support rail, and is supported thereby beneath the bed. The lift box has an crank hole on its side to permit the crank extension to extend therethrough from scissors lift to its drill connection.

Safety rails are also provided. Each safety rail includes support surface on the top for supporting the bed, and a narrower channel section on the bottom, thus forming a shoulder. A cutback on each end shortens the support surface but creates working space beneath the bed and above the safety rail, when the bed is supported thereon. The safety rails are about as long as the width of the bed. The cutbacks cause the support surface to be about ¾ of that width. The channel sections fit into the channels of the slate support rails of the integrated slate supports. When fitted thusly into the slate support rails, they are supported by the slate support rails, and can support the bed on the slate support surfaces in a stable fashion. When no longer needed, the safety rails can be removed.

Extension and retraction of the lift system, by driven rotation using a power drill, permits the lift system to move between at least four distinct configurations: lowered configuration, contact configuration, raised configuration, and safety configuration.

The lowered configuration has the scissors lift of the lift system fully retracted within the lift box, so that it is out of contact with the bed, and forms the spacing gap between the push plate assembly and the lower surface of the bed. This is the configuration during normal use of the billiards table. In this configuration, the bed is supported directly by the tub (and is in contact with the bed), specifically by the underrails, in addition to the slate support rails, but is not in contact with the lifting system.

The contact configuration is an intermediate step in the lifting process, where the scissors lift is extended sufficiently for the push plate assembly to contact the lower surface of the bed but not to lift the bed from the slate support faces of the underrails. In this configuration, the bed is still supported directly by the tub (and is in contact with the bed), specifically by the underrails, in addition to the slate support rails, but is not in contact with the lifting system.

The raised configuration is also an intermediate step in the lifting process, where the scissors lift is extended sufficiently for the bed to be fully lifted from the slate support faces of the underrails, beyond the slate recesses. In this position, the lower surface of the bed is high enough that the safety rails can be placed underneath the bed, above the slate recesses and slate support rails, and then the channel sections inserted down into the channels of those slate support rails. In this configuration, the bed is supported only indirectly by the tub, and directly by the lift system. It is thus in contact with the lift system.

The safety configuration is the final step in the lifting process, where the scissors lift is then retracted sufficiently for the lower surface of the bed to be lowered onto the support surface of the safety rails. In this configuration, the bed is supported only indirectly by the tub, and directly by the safety rails and the slate support system. It is not in contact with the lift system, but there is a working gap between the bed and the tub.

In this safety configuration, the safety rails stably support the bed so that the cloth maintenance can be performed. Once it is completed, the configurations can be applied in the reverse order: to the raised configuration to permit removal of the safety rails, through the contact configuration during retraction, and then to the lowered configuration for re-installation of removed parts of the billiards table and normal operation once reinstallation is completed.

### BRIEF DESCRIPTION OF THE FIGURES

FIGS. 1A-1C are, respectively, a top, left side, and front end views of part of a billiards table in a particular configuration. Omissions for clarity include the corner members, left side wall, front end wall, and legs from FIGS. 1B & 1C.

FIGS. 2A-2C are, respectively, a top, left side, and front end views of part of a billiards table in a different configuration. Omissions for clarity include the corner members, left side wall, front end wall, and legs from FIGS. 2B & 2C, and the side blinds in FIG. 2B and end blinds in FIG. 2C.

FIG. 3A is a partial cutaway top view of part of a billiards table.

FIGS. 3B-3D are section views along line C-C from FIG. 3A in three different configurations. Omissions for clarity include the corner members and right side section.

FIGS. 3E-3G are section views along line D-D from FIG. 3A in the same three configurations shown in FIG. 3B-3D. Omissions for clarity include the corner members and rear ends section.

FIGS. 4A-4C are top, front, left views of a billiards table during use of an embodiment of the invention.

FIGS. 5A-5C are, respectively, top, left side, and front end views of part of a billiards table. Omissions for clarity include the top rails, lift system, slate support system, corner members, and legs from FIGS. 5B & 5C, the side underrails from FIG. 5B, and the end underrails from FIG. 5C.

FIGS. 5D and 5E are, respectively, section views along lines A-A and B-B from FIGS. 5B & 5C, respectively (showing the side underrails hidden in FIG. 5B, and the end underrails hidden in FIG. 5C).

FIGS. 6A & 6B are front end and right side views, respectively, of a safety rail.

FIG. 7 is a top, left, rear, partially-exploded oblique view of an embodiment of the invention.

FIG. 8 is a top, left, rear, exploded, oblique view of an embodiment of the invention.

### DETAILED DESCRIPTION OF THE INVENTION

With reference to the Figures, an embodiment of billiards table 1 includes tub 20, one-piece bed 120 supported by tub 20, lift system 70 supported by tub 20 and located below bed 120, and slate support system 110 supported by tub 20 and located below bed 120.

Bed 120 lacks manufactured joints, and has top surface 122, edges 124, lower surface 126, and center of gravity 128. Cloth 15 is attached to bed 120 using glue 16 and covers top surface 122, around edges 124, and extends onto lower surface 126, to facilitate cloth 15 being tightened and fixed to bed 120.

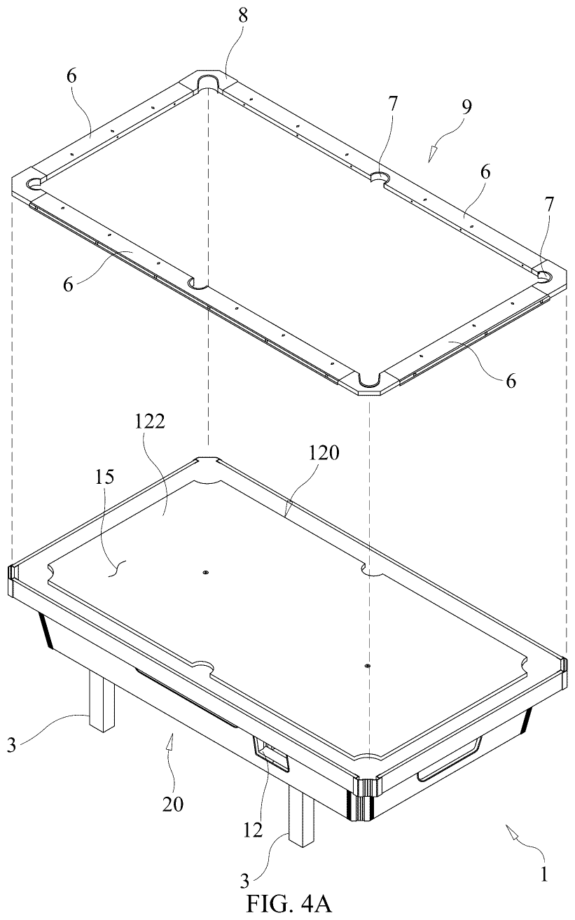

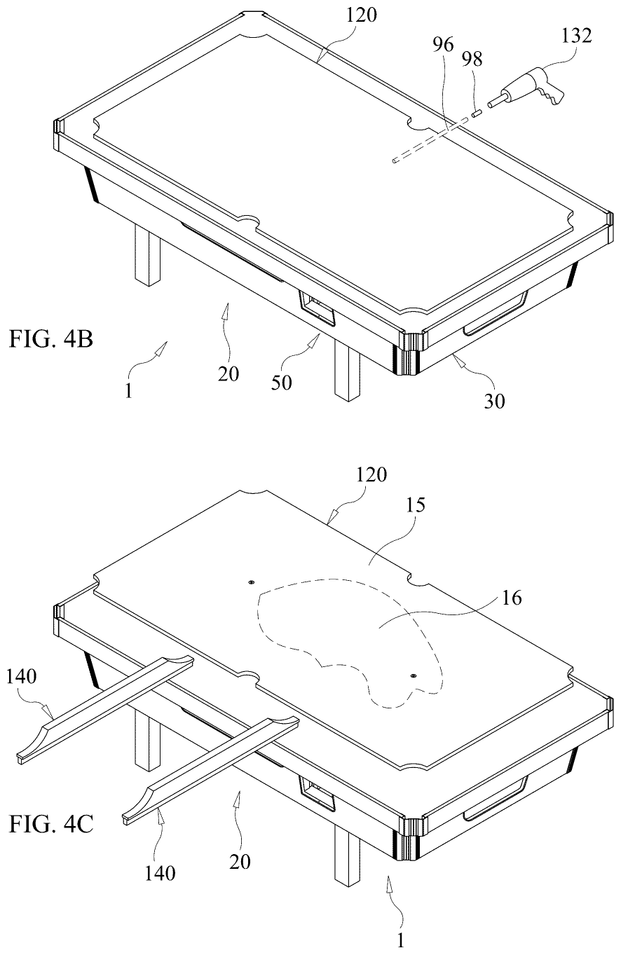

As shown in FIG. 4A, billiards table 1 also includes legs 3, and top rail assembly 9. Top rail assembly 9 includes top rails 6, ball pockets 7, and die castings 8 around ball pockets 6. Billiar table 1 also includes coin mechanism 12, and a ball return mechanism (not shown). Top rail assembly 9 is fixed using bolts in top rails 6 and die castings 8 to tub 20 at end underrails 32 of end sections 30 and side underrails 52 of side sections 50 and can be removed & replaced by operating the bolts.

Legs 3 support tub 20, which in turn supports top rail assembly 9, coin mechanism 12, and the ball return mechanism. It also supports, directly or indirectly (depending upon whether bed 120 is in lowered configuration 76, contact configuration 77, raised configuration 78, or safety configuration 79, the latter two in which bed 120 is elevated), bed 120, lift system 70, and slate support system 110.

Tub 20 includes corner members 22, two opposed end sections 30, and two opposed side sections 50, forming partial edges of a rectangle. One of corner members 22 connects front end section 30 and left side section 50, another of corner members 22 connects front end section 30 and right side section 50, another of corner members 22 connects rear end section 30 and left side section 50, and another of corner members 22 connects rear end section 30 and right side section 50.

End sections 30 each include end underrail 32 and end wall 38. End walls 38 each have larger face 44 that is end-facing surface 40 and end joint edge 42 of end-facing surface 40. End underrails 32 have slate support face 34 on an upper side, and wall joint recess 36 on a lower side. Slate support face 34 supports bed 120 when bed 120 is not elevated. Slate support face 34 is formed in slate recess 35 on that upper side to prevent lateral translation of bed 120.

Side sections 50 each include side underrail 52 and side wall 58. Side walls 58 each have larger face 64 that is side-facing surface 60 and side joint edge 62 of that side-facing surface 60. Side underrails 52 each have slate support face 54 on an upper side, and wall joint recess 56 on a lower side. Slate support face 54 supports bed 120 when bed 120 is not elevated. Slate support face 54 is formed in slate recess 55 on that upper side to prevent lateral translation of bed 120.

During construction of tub 20, end joint edges 42 of left & right end wall 38 are inserted into lower wall joint recess 36 of the corresponding left or right end underrail 32. This forms joints 46 edgewise. Likewise, side joint edges 62 of left & right side wall 58 are inserted into lower wall joint recess 56 of the corresponding left or right side underrail 52 forming joints 66 edgewise. Joint formation may include mechanical/chemical processes for fixing those joints.

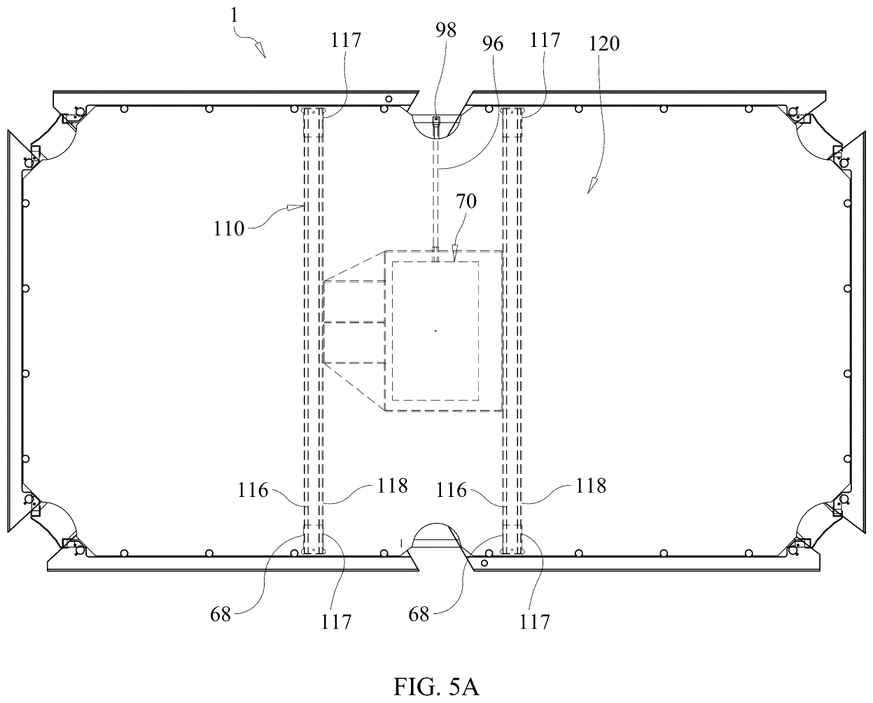

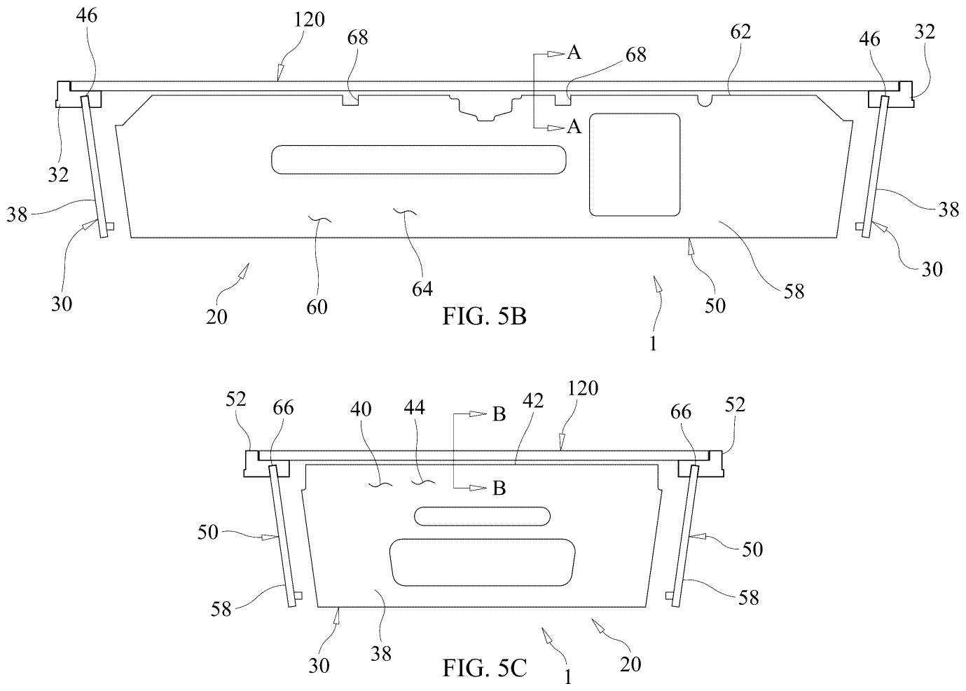

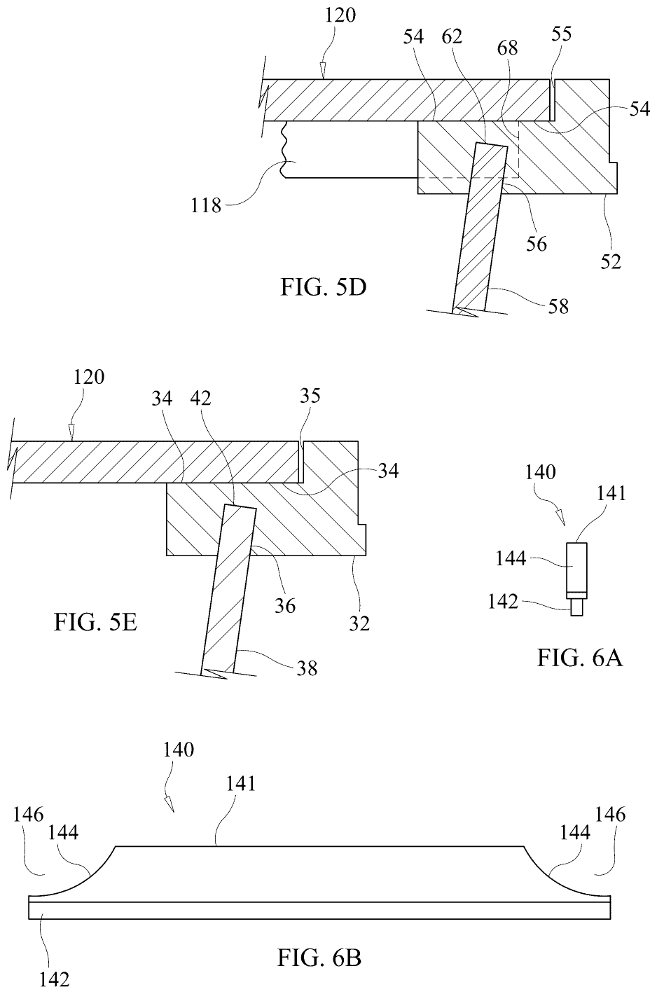

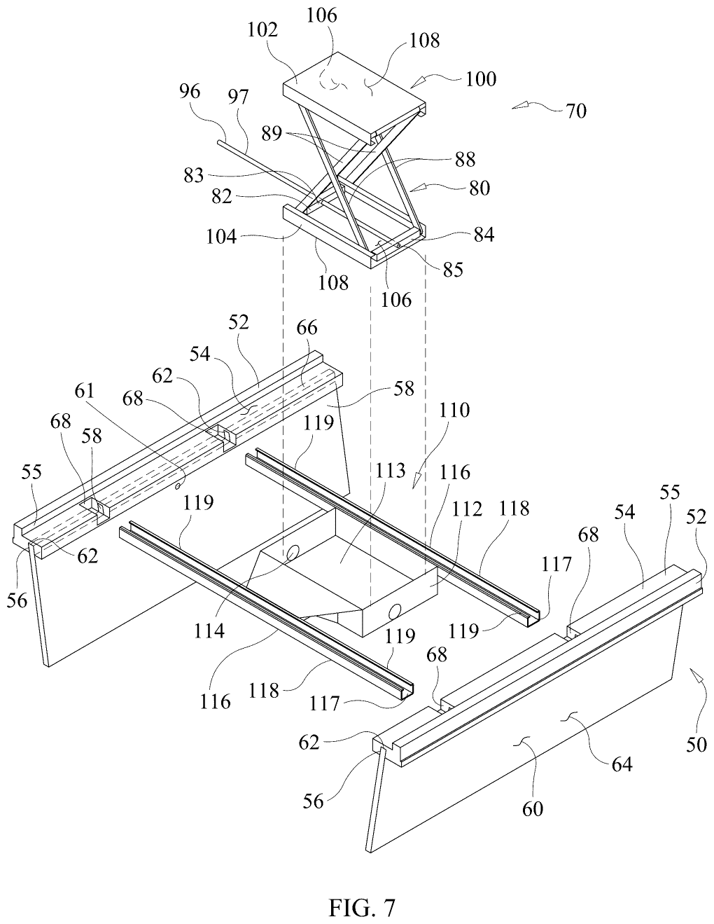

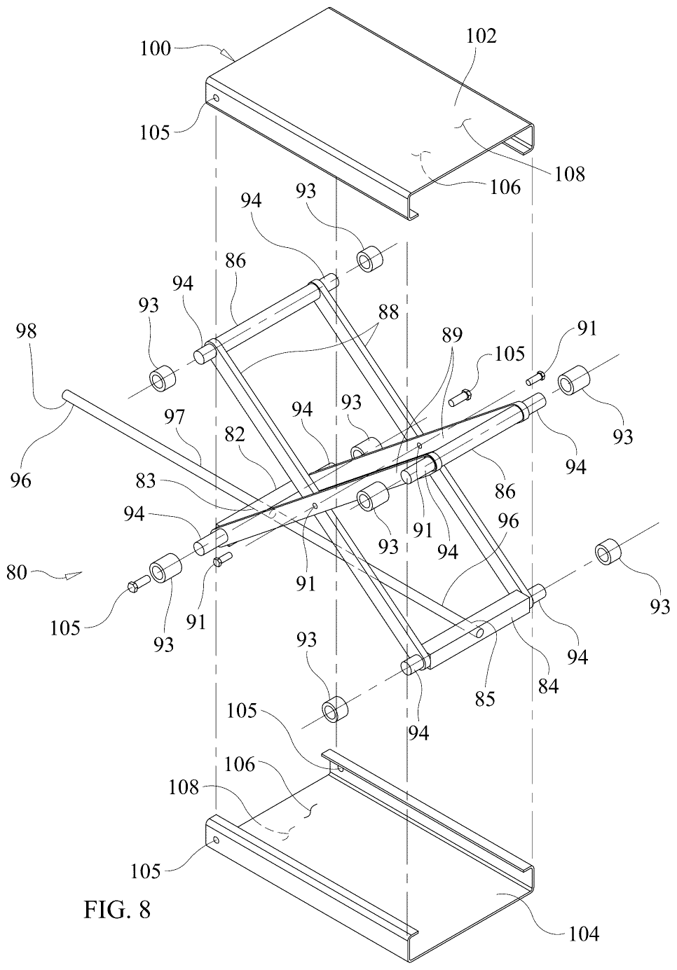

Each side underrail 52 and side wall 58 has a pair of pocket 68 formed therein. Pockets 68 on a given left or right side are spaced apart evenly, on either side of a midline of side underrail 52 and side wall 58. Pockets 68 on a given left or right side are situated across pocket 68 on the other left or right side that is on the same side of the midline. Pockets 68 accept and vertically support slate support system 110 via ends 117 of slate support rails 118 to form integrated slate supports 116. As best shown in FIG. 5D & FIG. 7, pockets 68 cut downward through slate support surface 54, and partially through wall joint recess 56, but not fully through side underrails 52. Ends 117 of slate support rails 118 rest on side underrails 52 in pockets 68 and are supported thereby. Pockets 68 extend partially through wall joint recess 56, and cut into side joint edges 62 of side walls 58. Ends 117 of slate support rails 118 also rest on side walls 58 in pockets 68 and are supported thereby.

Larger face 44 and larger face 64, as well as end-facing surface 40 and side-facing surface (the outward facing surfaces) are angled outward about 7 degrees as they extend upward. Right side wall 58 includes drill access hole 61 to permit a user (not shown) access to attach power drill 132 to drill connection 98 at the exterior end of crank extension 96.

Lift system 70 includes scissors lift 80 and push plate assembly 100. Slate support system 110 supports lift system 70 within tub 20.

Push plate assembly 100 includes upper push plate 102 above upper ends 86 of scissors lift 80, and lower push plate 104 below lower ends 82 & 84 of scissors lift 80. Upper push plate 102 and lower push plate 104 each include rolling surface 106 on the interior thereof to interact with scissors lift 80 and pushing surface 108 on the exterior thereof to exert force between lift box 112 of slate support system 110 and lower surface 126 of bed 120. Pushing surface 108 of upper push plate 102 is located below and aligned to center of gravity 128 of bed 120 remains in contact therewith as it elevates and lowers bed 120 between contact configuration 77, raised contact configuration 78, and safety configuration contact 79). Pushing surface 108 of lower push plate 104 is in contact with and supported by box bottom 113 of lift box 112 of slate support system 110. Rolling surfaces 106 accept and retain rolling members 93 of scissors lift 80 to permit it to extend and retract including laterally movement of moving lower end 84. Lower push plate 104 includes anchor connection 105 to fix anchored lower end 82 of scissors lift 80 to lower push plate 104. Upper push plate 102 includes anchor connection 105 that may be used to fix one of upper ends 86 of scissors lift 80 to upper push plate 102. Anchor connection 105 is a set of locking pins through a set of aligned holes through anchored lower end 82 and lower push plate 104 and set of locking pins through a set of aligned holes through one of upper end 86 and upper push plate 102.

Scissors lift 80 includes anchored lower end 82, moving lower end 84, and two upper ends 86. Scissors lift 80 also includes pair of struts 89 that connect anchored lower end 82 to one of upper ends 86, and another pair of struts 89 that connect moving lower end 84 to the other upper end 86. Pairs of struts 88, 89 are connected by pinned strut connection 91 at or around the midpoints thereof to permit pairs of struts 88, 89 to scissor, and thus to extend and to retract. Anchored lower end 82 and moving lower end 84 are elongated rectangular pieces connected between a given pair of struts 88, 89 and having axles 94 at each end. Upper ends 86 are elongated pieces having axles 94 at each end. Each one of pair of struts 88, 89 connects one end of one of upper end 86 to the same end of a lower end (anchored lower end 82 or moving lower end 84) by being rotatably connected to respective axles 94. On axles 94 distally of pairs of struts 88, 89, and at all four corners, are rolling members 93 that permit upper ends 86 and moving lower end 84 to roll along respective rolling surface 106 of upper push plate 102 and lower push plate 104 during the scissoring motion. Rolling members 93 on anchored lower end 82 may only rotate relative to rolling surface 106 but not translate, as anchored lower end 82 is pinned to lower push plate 104 by anchor connection 105, which may also be the case for one of upper ends 86 and upper push plate 102.

Moving lower end 84 includes threaded connection 85 at the midpoint thereof, and anchored lower end 82 has rotating collar 83 at the midpoint thereof and aligned to threaded connection 85. Scissors lift 80 includes crank extension 96 that can rotate and has acme thread 97 along at least the distal portion thereof. Crank extension 96, via acme thread 97, connects anchored lower end 82 to moving lower end 84 via rotating collar 83 and threaded connection 85. Crank extension 96 has drill connection 98 at its exterior, proximal, end, which extends to or near the drill access hole 61 in right side walls 58 and permits a user (not shown) to use power drill 132 to drive crank extension 96 to rotate. Crank extension is connected at rotating collar 83 to anchored lower end 82 but does not impart lateral force thereon, and is threaded through threaded connection 85 of moving lower end 84, closer to the distal end the crank extension 96, to impart lateral force thereon.

Crank extension 96 can rotate relative to both of anchored lower ends 82 and moving lower end 84 (via rotating collar 83 and threaded connection 85) but can only translate relative to moving lower end 84 and is fixed laterally to anchored lower end 82. Crank extension 96 cannot translate relative to anchored lower end 82 because rotating collar 83 fixes it axially thereto. But moving lower end 84 translates relative to crank extension 96 as crank extension 96 is rotated because crank extension 96 is connected thereto by threaded connection 85. Thus, driving crank extension 96 in one direction will force moving lower end 84 closer to anchored lower end 82 (by it rolling on rolling members 93 along rolling surface 106 of lower push plate 104) to extend scissors lift 80 upward. In doing so, one or both of upper ends 86 approach each other (by rolling on rolling members 93 along rolling surface 106 of upper push plate 102). Driving crank extension 96 in the opposite direction will force moving lower end 84 farther from anchored lower end 82 (likewise by rolling) to retract the scissors lift downward, with one or both of upper ends 86 likewise rolling.

Slate support system 110 is supported by tub 20 and includes lift box 112, and two integrated slate supports 116 fixed to lift box 112.

Integrated slate supports 116 have opposing ends 117 and extend transversely (from side wall 50 to side wall 50), with each of the opposing ends supported by tub 20. Pockets 68 of side sections 50 supports ends 117 of integrated slate supports 116. Integrated slate supports 116 are slate support rails 118 which have opposing ends 117 and a channel-shaped cross-section therebetween, forming channel 119 with the open side upwards. Slate support rails 118 contact lower surface 126 of bed 120 in lowered configuration 76 to support bed 120.

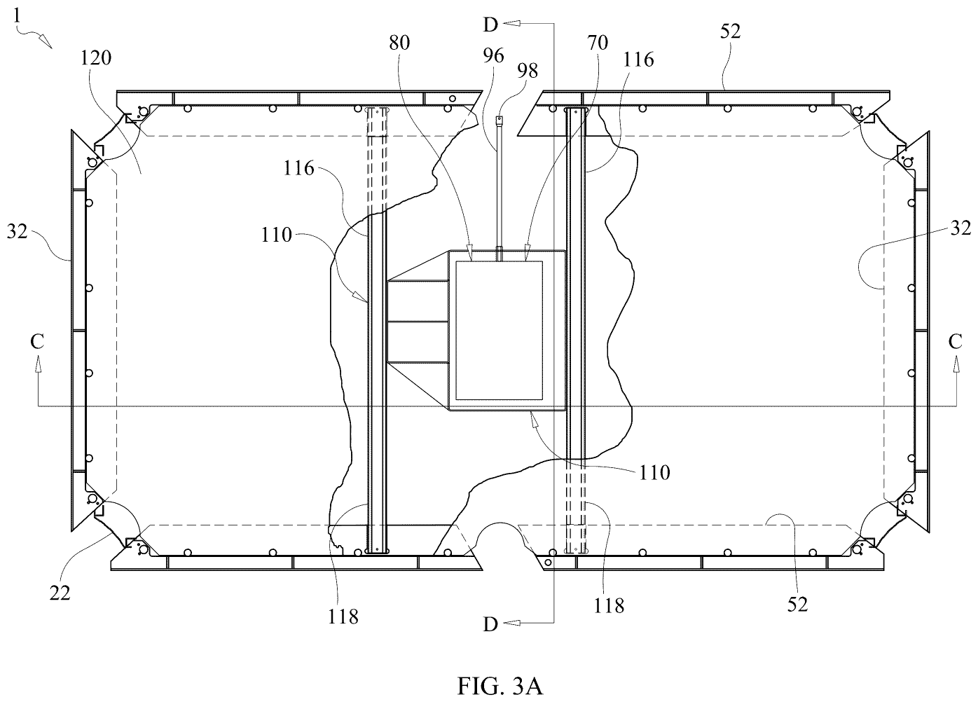

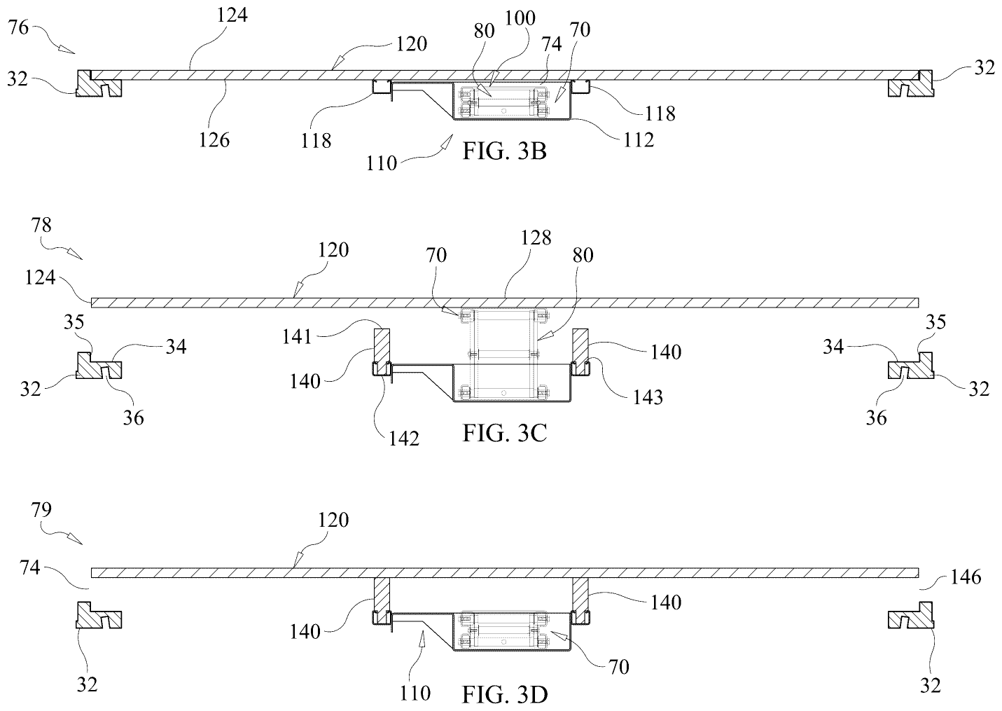

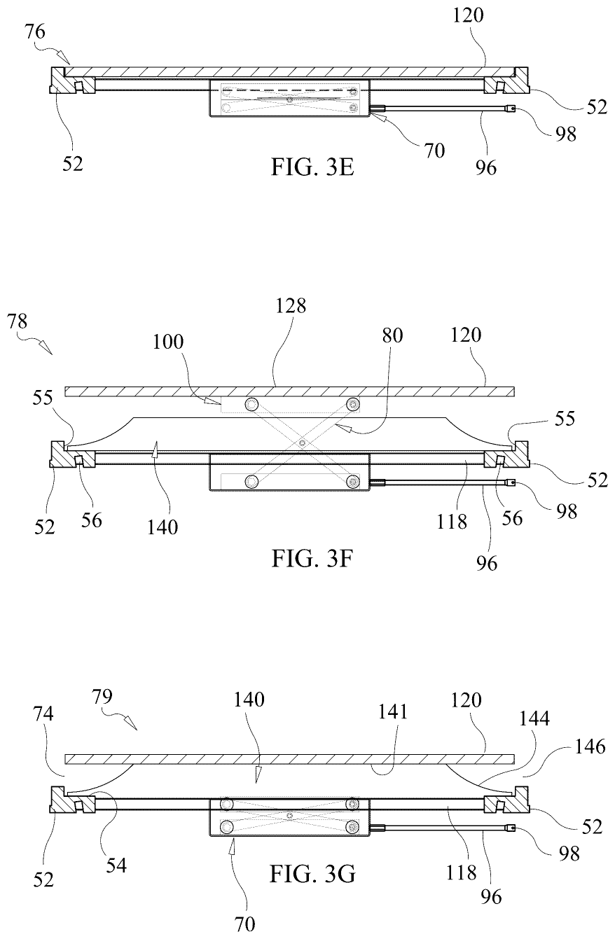

Lift box 112 supports lift system 70 and includes box bottom 113 which supports lower push plate 104. Lift box 112 is deep enough to provide spacing gap 72 (see FIG. 3B) between upper push plate 102 and lower surface 126 of bed 120 when scissors lift 80 is retracted in lowered configuration 76. Lift box 112 is integrated with integrated slate supports 116 and fixed to each slate support rails 118 which support lift box 112. Lift box 112 has crank hole 114 on one side (corresponding to drill access hole 61) to permit crank extension 96 to extend therethrough from scissors lift 80 toward drill connection 98.

Each safety rail 140 includes support surface 141 on its top for supporting bed and channel section 142 on the bottom with shoulder 143 therebetween. Safety rails 140 are about as long as the width of bed 120. Cutbacks 144 on each end reduce support surface 141 to about ¾ of that width. Cutbacks 144 create working space 146 beneath bed 120 and above safety rail 140 in safety configuration 79. Channel sections 142 fit into channels 119 of slate support rails 118. Slate support rails 118 can support safety rails 140 at the bottom face of channel section 142, or on shoulder 143, or both. When fitted thusly into slate support rails 118, safety rails 140 support bed 120 on slate support surfaces 141 in a stable fashion. When no longer needed, safety rails 140 can be removed.

Lift system 70 has at least four distinct configurations involving extension and retraction of scissors lift 80 and push plate assembly 100: lowered configuration, contact configuration, raised configuration, and safety configuration. Lift system 70 moves therebetween by providing a driven rotation input (e.g. using a power drill).

In lowered configuration 76, scissors lift 80 is fully retracted within lift box 112 to forms spacing gap 72 between push plate assembly 100 and lower surface 126 of bed 120. Slate support faces 34 of end underrails 32, slate support faces 54 of side underrails 52, and slate support rails 118 support bed 120, but not lift system 70.

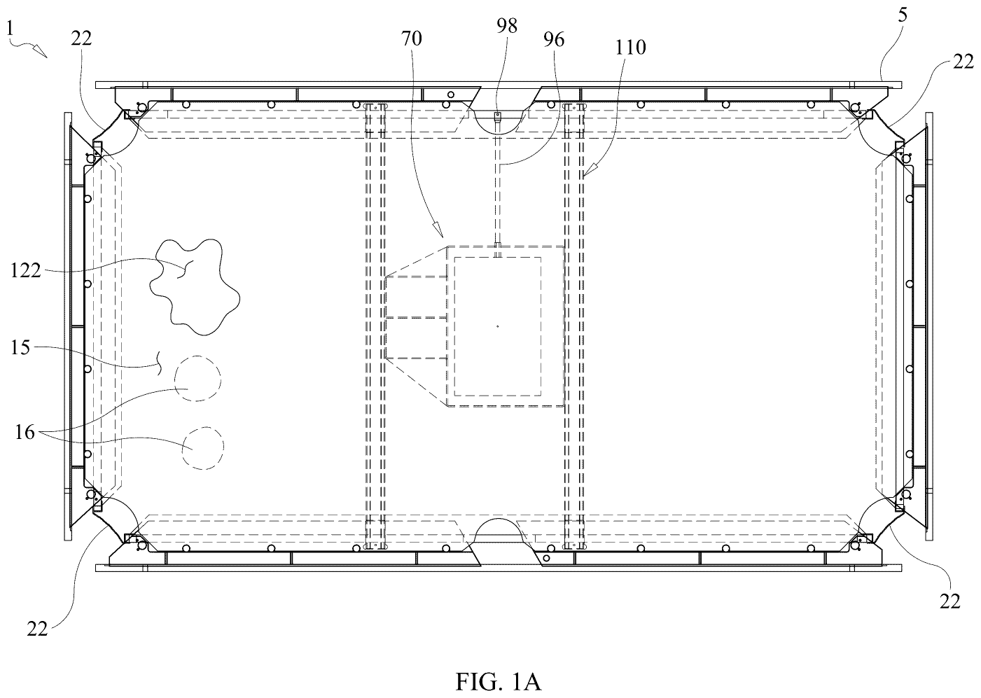

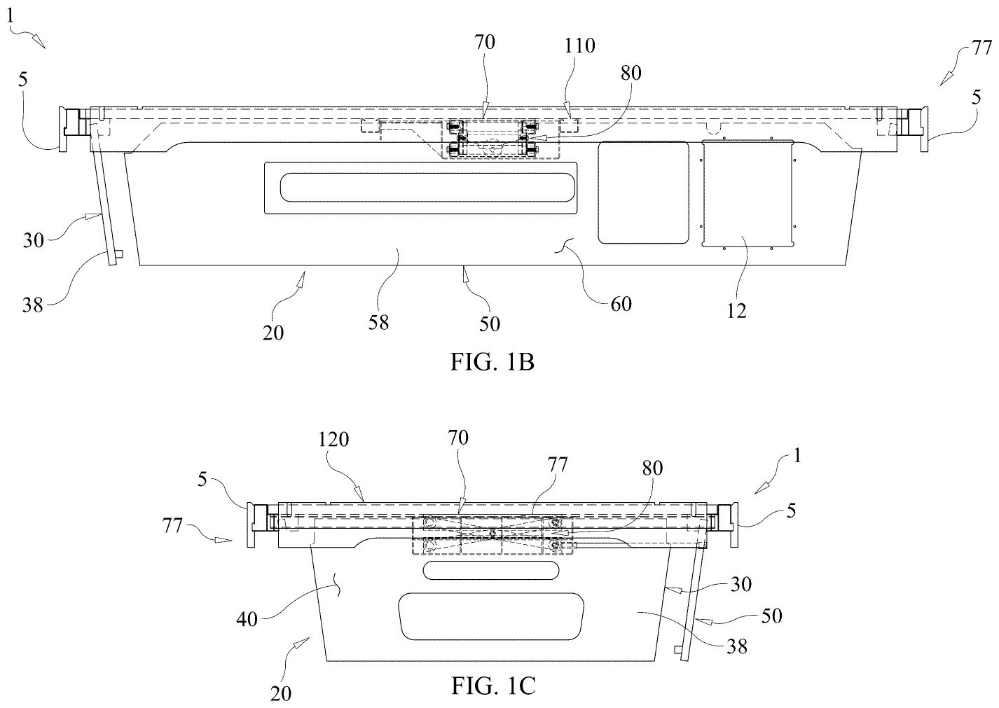

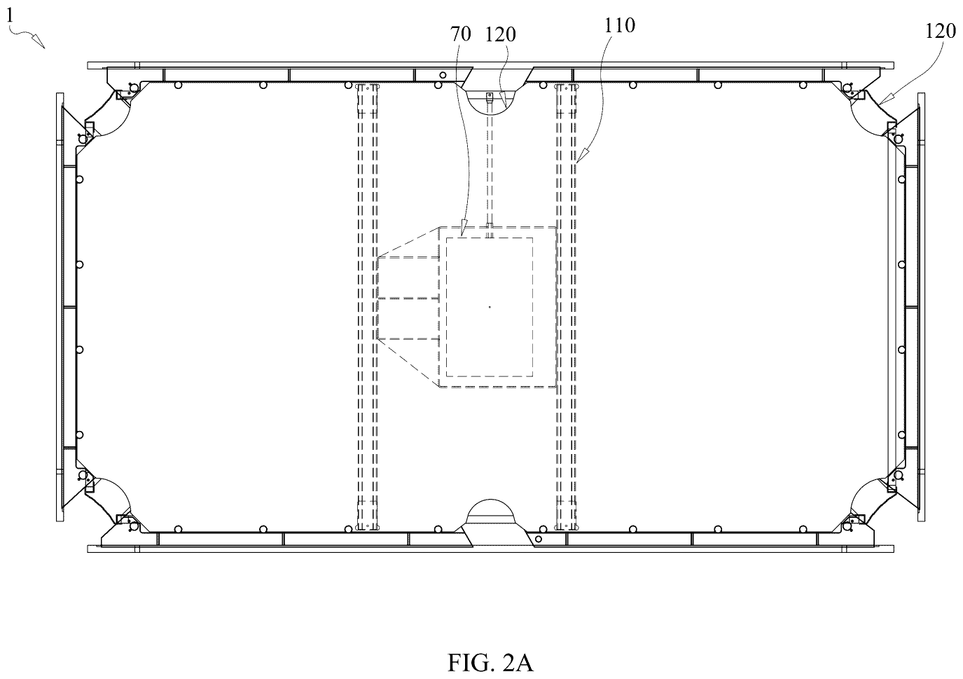

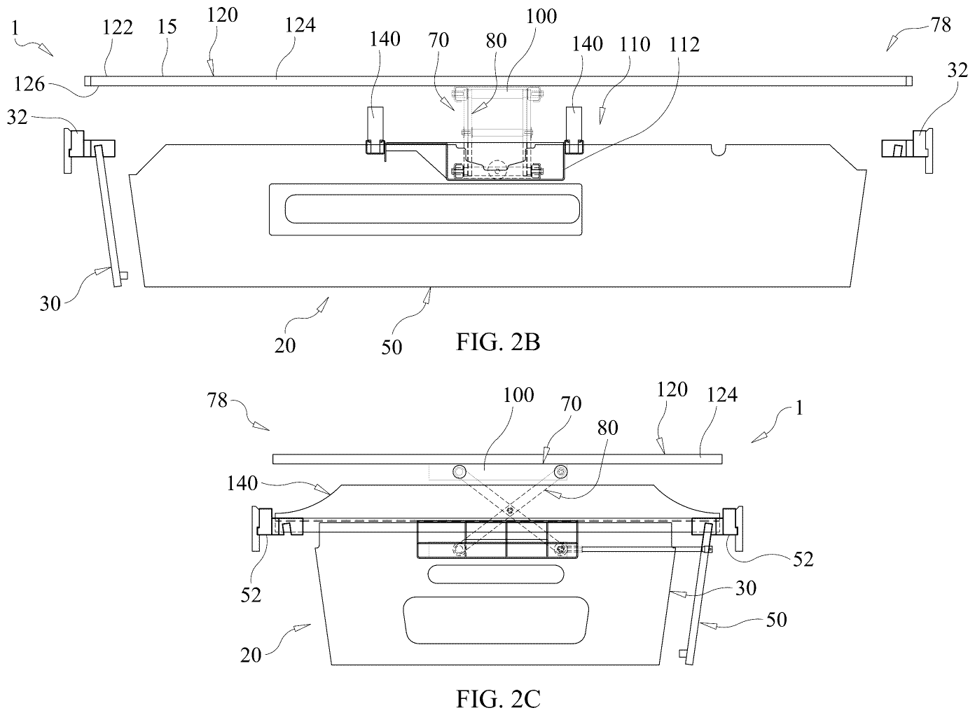

In contact configuration 77 (see particularly FIGS. 1B & 1C), an intermediate step, scissors lift 80 is extended sufficiently for upper push plate 102 to contact lower surface 126 of bed 120 but not to lift bed 120 from end sections 30 or side section 50 or slate support rails 118. Slate support faces 34 of end underrails 32, slate support faces 54 of side underrails 52, slate support rails 118, and upper push plate 102 support bed 120

In raised configuration 78, another intermediate step, scissors lift 80 is extended sufficiently for bed 120 to be fully lifted by upper push plate 102 from slate support rails 118, from slate support faces 34 of end underrails 32 and slate support faces 54 of side underrails 52, and beyond slate recesses 35 of end underrails 32 and slate recesses 55 of side underrails 52. Raised configuration 78 places lower surface 126 of bed 120 high enough that safety rails 140 can be placed therebeneath and then channel sections 142 inserted down into channels 119 of slate support rails 118. Lift system 70 directly supports bed 120 and tub 20 only supports bed 120 indirectly.

In safety configuration 79, scissors lift 80 is retracted sufficiently for lower surface 126 of bed 120 to be lowered into contact with support surface 141 of safety rails 140. Elevation of bed 120 on safety rails 140 forms working gap 146 between lower surface 126 and tub 20, specifically end underrails 32 and side underrails 52. Safety rails 140, via slate support system 110, directly support bed 120, and tub 120 only supports bed 120 indirectly, and lift system 70 is not in contact therewith.

In safety configuration 79, safety rails 140 stably support bed 120 so a user can safely conduct maintenance on cloth 15 and glue 16. Once maintenance is completed, the configurations can be applied in the reverse order: to raised configuration 78 to remove safety rails 140, through contact configuration 77 during retraction, and then to lowered configuration 76 for re-installation of removed parts of billiards table 1 and normal operation once reinstallation is completed.

Thus, a method of billiard table maintenance may include lifting the bed from the tub using a driven rotation input to a lift system, removing the existing cloth, placing, stretching, and gluing the new cloth to the upper surface, edges, and lower surface of the bed, and then lowering the bed back onto the tub. Further steps may include operating a lift system by supporting a scissors lift in a lift box on slate support rails, extending that scissors lift using the driven rotation input, contacting the bed with a push plate assembly, lifting the bed on the push plate assembly. Further steps may include creating a working gap, inserting one or more safety rails, including placing channel sections of safety rails into channels of slate support rails, retracting that scissors lift using the driven rotation input, and supporting the bed on the slate support rails. Further steps may include reversing the steps, removing the safety rails, and retracting the lift system.

1. A billiards table comprising:
a tub;
a one-piece bed supported by the tub; and
a lift system supported by the tub and located below the one-piece bed.

2. The billiards table of claim 1, the one-piece bed comprising a single piece of slate without manufactured joints.

3. The billiards table of claim 1,
the lift system comprising a scissors lift.

4. The billiards table of claim 3,
the lift system further comprising
an upper push plate above the scissors lift; and
a lower push plate below the scissors lift.

5. The billiards table of claim 3,
the scissors lift comprising
an anchored lower end; and
a moving lower end; and
a crank extension connected to the anchored lower end and the moving lower end.

6. The billiards table of claim 1,
the lift system having at least a lowered configuration and a raised configuration;
the one-piece bed supported directly by the tub in the lowered configuration and indirectly by the tub and directly by the lift system in the raised configuration.

7. The billiards table of claim 6,
the lowered configuration having a spacing gap between the lift system and the one-piece bed and having contact between the one-piece bed and the tub; and
the raised configuration having contact between the lift system and the one-piece bed and having a working gap between the one-piece bed and the tub.

8. The billiards table of claim 1,
further comprising a slate support system supported by the tub; and
the lift system supported by a slate support system.

9. The billiards table of claim 8,
the slate support system comprising
a lift box supporting the lift system; and
one or more integrated slate supports fixed to the lift box.

10. The billiards table of claim 8,
the slate support system comprising two integrated slate supports, each support having opposing ends;
said integrated slate supports extending transversely, with each of said opposing ends supported by the tub.

11. The billiards table of claim 8,
the slate support system comprising two slate support rails;
each slate support rail having two opposing ends and a channel-shaped cross-section therebetween;
each of said opposing ends supported by the tub; and
the lift box fixed to each slate support rail and supported thereby.

12. The billiards table of claim 1,
the tub comprising opposed end sections and opposed side sections;
the end sections each comprising an end underrail and an end wall; and
the side sections each comprising a side underrail and a side wall.

13. The billiards table of claim 12,
each of the side underrails and the side walls forming a pair of pockets;
the lift system supported by the pairs of pockets.

14. The billiards table of claim 13,
the lift system comprising two slate support rails;
each of the slate support rails supported by two of the said pockets.

15. A method of billiards table maintenance, comprising:
lifting a one-piece bed from a tub;
the lifting step comprising applying driven rotation input to a lift system;
the lift system supported by the tub below the one-piece bed.

16. The method of claim 15, further comprising:
supporting the lift system on slate support rails; and
supporting the bed on said slate support rails prior to the lifting step.

17. The method of claim 15:
the applying step further comprising extending a scissors lift using the driven rotation input; and
the lifting step further comprising lifting the bed on a push plate assembly.

18. The method of claim 15, further comprising:
inserting one or more safety rails; and
lowering the bed on the safety rails creating a working gap.

19. The method of claim 15, further comprising:
moving the lift system from a lowered configuration to a raised configuration.

20. The method of claim 19:
the moving step further comprising the lift system passing through a contact configuration between the lowered configuration and raised configuration.

21. The method of claim 20:
the moving step further comprising lowering the lift system to a safety configuration after the raised configuration.

22. A billiards table comprising:
a tub, the tub comprising
opposed end sections and opposed side sections;
the end sections each comprising an end underrail and an end wall; and
the side sections each comprising a side underrail and a side wall;
a slate support system;
the slate support system supported by the side sections; and
a one-piece bed;
the one-piece bed supported by the slate support system and the end sections and the side sections.

23. The billiards table of claim 22,
the slate support system comprising two slate support rails, each of said rails having two ends;
each of the side sections forming a pair of pockets; and
each of said rails supported at the ends by side walls and the side underrails at the pockets.

24. The billiards table of claim 22,
the end walls joined edgewise to the end underrails;
the side walls joined edgewise to the side walls; and
the side walls and end walls each having an outward-facing larger face oriented substantially vertically.

25. The billiards table of claim 22,
further comprising a lift system;
the lift system comprising a scissors lift supported by the slate support system;
the scissors lift comprising
an anchored lower end;
a moving lower end; and
a crank extension connected to the anchored lower end and the moving lower end.
